(19) United States
(12) Patent Application Publication
(10) Pub. No.: US 2010/0287131 A1
(43) Pub. Date: Nov. 11, 2010

(54) SYSTEM AND METHOD FOR DYNAMIC MULTI-PLATFORM HANDLER ASSIGNMENT

(75) Inventor: Wayne W. Church, Clinton, CT (US)

Correspondence Address: MCCORMICK, PAULDING & HUBER LLP, CITY PLACE II, 185 ASYLUM STREET, HARTFORD, CT, 06103, US

(73) Assignee: Hartford Fire Insurance Company, Hartford, CT (US)

(21) Appl. No.: 12/463,654

(22) Filed: May 11, 2009

(51) Int. Cl. G06N 5/02; G06Q 10/00

(52) U.S. Cl. 706/47; 705/11; 705/9

(57) ABSTRACT

According to one embodiment, an intelligent contact handler management system can proxy contact inquiry requests, aggregate contact handler availability, capability and expertise and dynamically select, reserve and assign an optimal contact handler from a group of contact handlers to the contact inquiry. An intermediate communications proxy mediates customer inquiry requests and manages communications between a central contract management server and a plurality of communication sub-systems in communication with contact handlers. Community derived expertise information is used to select a contact handler.

### BACKGROUND OF THE INVENTION

Many large entities, such as insurance companies, process and handle many thousands of third party and subscriber/customer inquiries on a daily basis. Different customer service/care procedures and guidelines may need to be applied to different types of inquiries, most of which are assigned in a manual fashion. Typically the customers and the respective contact handler/customer care representatives are forced to work through archaic and inefficient procedures to route and manage inquiries. Generally so called Customer Contact Centers or Call Centers handle various types of customer and third party inquiries in a disjointed fashion with separation administration systems for different communication mediums such as telephone, email, internet, etc. Furthermore these contact centers simply route inquiries based on pure availability of the contact handler or some use rudimentary “skills-based routing” technology to route calls to an appropriate call or contact handler based on their general knowledge and experience. These qualifications may vary but may include knowledge of a particular product line or having the regulatory approval to handle a particular type of contact. These Contact Centers also use rudimentary technology to determine whether or not a contact handler or agent is available to handle a contact.

The problem with current approaches is that contact handler selection is not based on a comprehensive technical, substantive and holistic evaluation of the various considerations which may affect a contact handler's ability to appropriately handle an inquiry. Pertinent considerations such as the handler's historical performance, their communication capabilities, their multi-tasking ability, their general interests and expertise and peer review based evaluation are typically not considered in a multi-platform contact center environment.

### SUMMARY OF THE INVENTION

In accordance with the first aspect of the present invention there is provided a system for the aggregation and management of contact handler capability, availability and expertise across a wide range of contact delivery modes so that contact inquiries are routed to an optimal contact handler that is capable, available and possesses the required expertise to handle the contact inquiry. The system will accept multiple capability or “skills” inputs from the various systems, communities or devices which can intelligently gauge whether or not a handler is capable of handling a particular contact. The system of the present invention will have the capability to assign inquiries to the most qualified, capable, and available handlers though a comprehensive evaluation of each inquiry and each handler based on a number of business rules which optimize the selection process.

In one embodiment the invention is an intelligent contact handler management system for routing contact inquiries based on contact handler availability, capability and expertise which includes a plurality of contact handler communication devices adapted to receive and transmit information; a communication interface in communication with said plurality of contact handler communication devices, said communication interface adapted for a plurality of communication capabilities; a processor coupled to the communication interface; and a storage device in communication with said processor for storing instructions adapted to be executed by said processor to receiving a contact inquiry; parsing the contact inquiry to determine a contact mode and a contact type; determining an optimal contact handler selection based at least in part on contact mode, contact type, contact handler availability, contact handler capability and contact handler expertise, wherein contact handler expertise is based at least in part on community derived expertise information; dynamically generating at least a first contact handler assignment; and transmitting notification via said communication interface to said contact handler communication device of said at least first contact handler assignment.

In another embodiment, the invention is a computer implemented method of intelligently routing a plurality of customer contact inquiries, comprising: receiving a customer inquiry in a communications module; processing said customer inquiry in an inquiry evaluation module to determine preliminary inquiry routing information; comparing in a handler director module said preliminary routing information with contact handler capability, availability and expertise information; dynamically generating in said handler director module a contact handler assignment based at least in part on the preliminary routing information, contact handler capability, availability and expertise information; reserving a primary handler through a reservation module based on the handler assignment generated; notifying said primary handler through a notification module; transmitting said inquiry data to said contact handler through said communications module; and establishing a communications link between the contact handler and the customer through said communications module.

### BRIEF DESCRIPTION OF THE DRAWINGS

FIG. 1 is a block diagram of a dynamic availability, capability and expertise based contact handler assignment and management system and network according to some embodiments of the present invention.

FIG. 2 is a block diagram of a dynamic availability, capability and expertise based contact handler assignment and management server system according to some embodiments of the present invention.

FIG. 3 illustrates an exemplary communications interface diagram in accordance with some embodiments of the invention.

FIG. 4 illustrates an exemplary input/output data flow for contact handler selection according to some embodiments of the present invention.

FIG. 5 illustrates a communication input/output data flow according to some embodiments of the present invention.

FIG. 6 illustrates an exemplary assignment data process flow according to some embodiments of the present invention.

FIG. 7 illustrates a computerized method according to some embodiments of the present invention.

FIG. 8 illustrates another computerized method according to some embodiments of the present invention.

### DETAILED DESCRIPTION OF THE PREFERRED EMBODIMENTS

Pursuant to some embodiments, a dynamic availability, capability and expertise based contact handler assignment and management system and method is provided in which the dynamic availability, capability and expertise based contact handler assignment and management system is configured to route a customer contact to a contact handler based at least in part on a contact type and on information identifying and characterizing the customer and their respective inquiry, along with contact handler availability, capability and expertise based information. Applicant has discovered that a dynamic availability, capability and expertise based contact handler assignment and management system pursuant to some embodiments results in surprising and desirable improvements in contact inquiry handler routing management and processing efficiency and accuracy. Such efficiencies result in improved customer satisfaction, greater contact handler job satisfaction and reduced agent or handler costs. As used herein, the term “availability” refers generally to a contact handlers' physical and/or electronic ability to engage in communications via one or more modes of communication. The term “capability” refers generally to one or more modes of communication such as electronic mail, chat, telephony, Internet, facsimile, video conference, etc. The term “expertise” refers generally to knowledge, skill and experience of a contact handler. The terms “contact handler” is used herein to designate an agent, an operator, an insurance company employee or customer care technician or representative. Additionally, the “contact handler” may be an electronic module configured to respond to customer or third party inquiries.

A technical effect of some embodiments of the invention is improved customer and third party inquiry handler routing, management and processing with substantially increased accuracy for matching contact handlers and third party/customer inquiries on both an availability and a substantive content basis. Prior to embodiments of the present invention, management, routing and processing was inefficient and subject to errors, delay and selection. Embodiments, using dynamic handler selection methodologies and algorithms, validation and other techniques, substantially reduce the errors and inefficiencies. With this and other advantages and features that will become hereinafter apparent, a more complete understanding of the nature of the invention can be obtained by referring to the following detailed description and to the drawings appended hereto.

Embodiments of the present invention may be used with desirable results in a number of different inquiry routing and processing environments. For example, embodiments may be used to handle inquiries regarding new and existing insurance policies and inquiries, such as policies and inquiries under auto, life, property, or workers compensation policies. Those skilled in the art will recognize that features described in the illustrative examples contained herein may be used to desirable advantage in other inquiry processing situations.

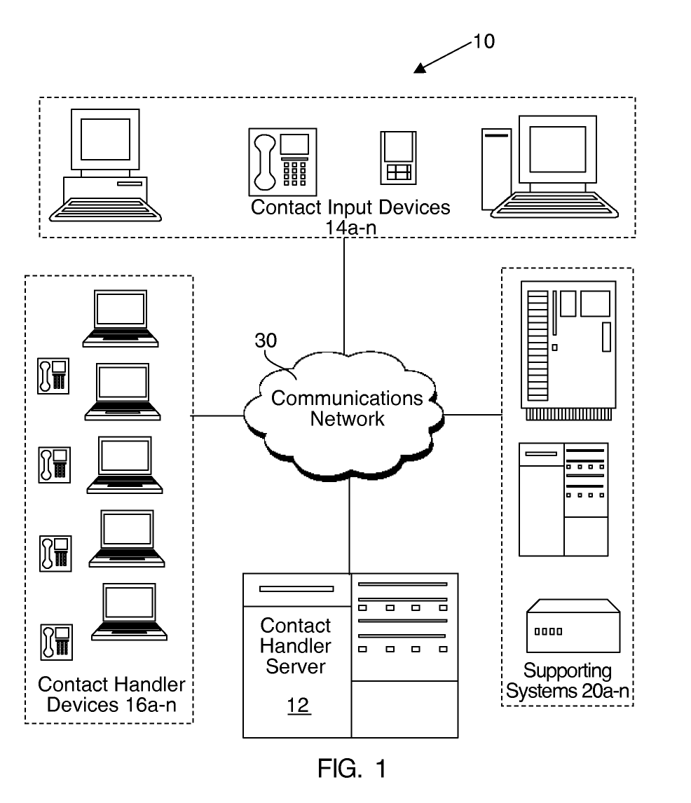

Reference is now made to FIG. 1 where a dynamic multi-platform availability, capability and expertise based contact handler assignment and management system 10 pursuant to some embodiments is shown. As depicted, dynamic availability, capability and expertise based contact handler assignment and management system 10 includes a contact handler management server 12 in communication with a number of contact/third party data input and entry devices 14a-n and agent or contact handler data communication devices 16a-n. Pursuant to some embodiments, a wide variety of types of input/output devices may be supported, including, for example, computer systems, telephones, handhelds or the like. Server 12 is also in communication with a number of sub-systems or data sources 20a-n such as insurance product and information systems and data sources and customer information systems and data sources. Pursuant to some embodiments, dynamic availability, capability and expertise based contact handler assignment and management system 10 is comprised of one or more computing environments and/or systems, such as servers, interacting to process, route, analyze and manipulate data and information received from a wide variety of different data input and entry devices 14a-n and store, forward, route or otherwise manipulate the data by communication and interaction with a number of different agent of contact handler data communication devices 16a-n in further communication with a number of different systems or data sources 20a-n. Contact management server 12 facilitates optimal management and matching of inquiries originating at data input and entry devices 14a-n with one or more contact handler data communication devices 16a-n.

Embodiments provide a dynamic intelligent rules, historical and feedback based system that ensures that customer and third party contact inquiries through any of a number of different types of devices are managed and routed in a logical, efficient and accurate fashion, thereby reducing errors and ensuring that the inquiries are properly handled and inquiries are processed appropriately.

As will be described further below, contact management server 12 may also interface or interact with a wide variety of supporting or back end systems 20a-n, such as, for example, inquiries systems or data stores, support systems or data stores, and third party vendor systems. As will be described further below, contact management server 12 provides a standardized interface to these back end systems. For example, in some embodiments, contact management engine 12 may interact with third party vendor systems to provide services associated with a contact initiated by a user interacting with contact management engine 12. As a specific illustrative example, contact management engine 12 may interact with third party provider systems, allowing a contact inquiry associated with that third party provider to interact if necessary. Further benefits and features will become apparent to those skilled in the art upon reading this disclosure.

Referring to FIG. 1, communication network 30 may include various different types of networks and subnetworks, including one or more wireless telecommunications networks and/or one or more landline networks. Communications networks as used herein applies to both nationwide and worldwide communication of voice, multimedia and/or data. As used herein, communications networks include public communications networks, such as the Public-Switched Telephone Network (PSTN), terrestrial and/or satellite cellular networks, and/or the Internet. In one embodiment, one or more of the subnetworks may be a wireless telecommunications network and another subnetwork is a landline network such as the Internet. Thus, in various embodiments either or both of the contact input devices 14a-n and/or contact handler devices 16a-n might be a mobile device equipped to operate on a wireless network, such as a cellular telephone, personal digital assistant (PDA), notebook computer, etc.

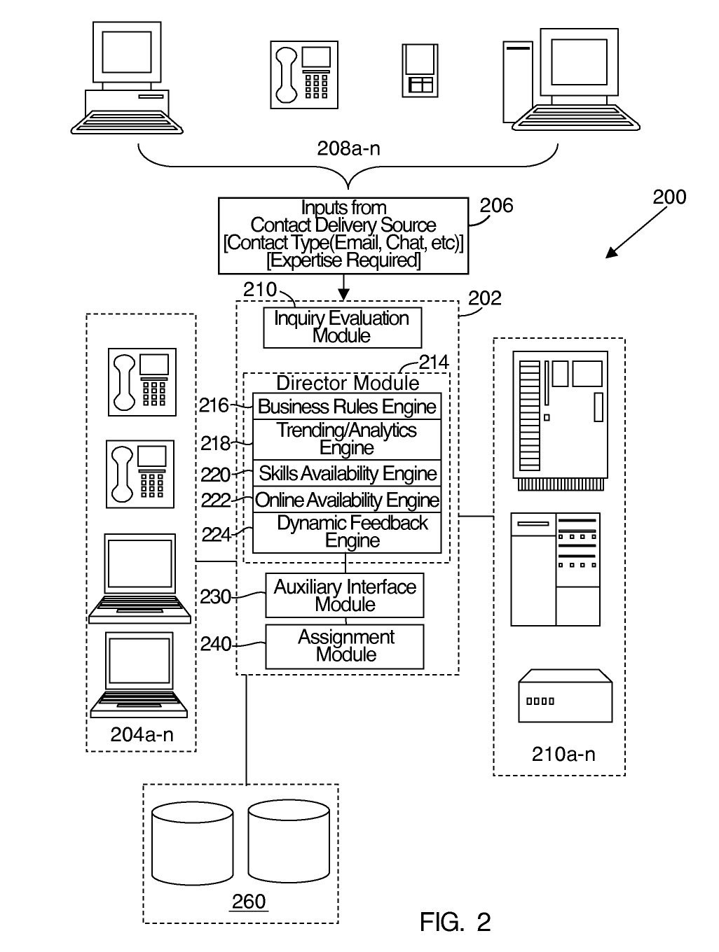

Reference is now made to FIG. 2, where a dynamic availability, capability and expertise based contact handler assignment and management system 200 pursuant to some embodiments is shown. As shown, dynamic availability, capability and expertise based contact handler assignment and management system 200 includes a contact management and processing server 202 in communication with a number of client, contact handler and vendor devices, data sources or entities. For example, as depicted, contact management and processing server 202 is in communication with one or more contact handler devices 204a-n, a client interface layer 206, one or more client devices 208a-n, and a number of data stores and third party systems 210a-n. Communications may occur over any type of network familiar to those skilled in the art that can support data communications using any of a variety of commercially-available protocols, including without limitation TCP/IP, SIP, SNA, IPX and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2 G, 2.5 G, 3 G, 4 G, Wimax, WiFi, CDMA 2000, WCDMA, the Bluetooth protocol known in the art, and/or any other wireless protocol); and/or any combination of these and/or other networks.

Referring still to FIG. 2, a potential customer, current policy holder, vendor or other third party may operate a client device 208a-n to initiate a contact with an insurance company operating server 202 and/or an insurance company having a third party operating server 202. Pursuant to some embodiments, a number of different types of client devices 208a-n may be used to initiate a contact or inquiry. For example, one specific client device may be a telephone, a handheld, portable or desktop computer, a kiosk, a wireless handset, or the like. Each client device may initiate communication with contact processing server 202 via a client interface layer or proxy 206. Client interface layer 206 may be or include a number of different types of interfaces, depending on the type of client device 208 used. For example, client interface layer 208 may include a PBX, an interactive voice response (“IVR”) unit or other telephone switching mechanism to receive telephone contact from a customer operating a telephone as a client device or an Instant Messaging gateway, an email gateway or server or other communication interface. Client interface layer 206 may also include an Internet-based layer allowing a client to initiate contact via a computing device over the Internet or other networks such as an online help facility, chatroom, blog, forum or other online communication mechanism.

Pursuant to some embodiments, client interface layer 206 may include some functionality to solicit customer/third party input or identify a customer/third party and retrieve basic information about the contact in conjunction with an inquiry evaluation module 210. Inquiry evaluation module 210 assists in determining a contact mode, content and identification to assist in matching contact inquiries with optimal contact handlers. For example, inquiry evaluation module 210 may determine whether the customer or third party is communicating via electronic mail, internet, chat, phone, etc. and also make a preliminary determination about the contact inquiry content, e.g is the inquiry about a policy, a product, a claim, a dispute, etc. By way of further example, in an embodiment in which the client device is a telephone, client interface layer 206 and/or inquiry evaluation module 210 may operate to perform a reverse telephone lookup or other identification to identify the customer. In some embodiments, an Interactive Voice Response Unit or phone based menu system may request certain identifying or content related information from the customer. In some embodiments, a Web-based interface may request certain identifying information from the customer such as through a Web form or other online input facility. This identifying information may be used to route the customer to an appropriate handler for further processing based on the substantive input from the customer/third party and the availability of the appropriate handler.

In some embodiments, it is contemplated that the contact inquiry mode is matched with the contact handler such that a contact inquiry over electronic mail is paired with a contact handler on electronic mail. In other instance, based on contact handler and/or customer input, a contact handler expressing a preference for receiving telephony base inquiries may be matched with a contact inquiry via electronic mail which has requested that a response be provided by telephony. In another instance, a contact inquiry over the internet may request that a response to the inquiry be provided via facsimile, etc. In one illustrative example discussed in more detail later herein, in determining and making contact handler assignments hereunder, contact inquiry preferences may be weighted more heavily than contact handler preferences as defined by one or more business rules through server 202.

Referring still to FIG. 2, a number of contact handler devices 204a-n may be provided to interact with and respond to requests from client devices 208a-n. In the present invention, typically a plurality of handler devices 204a-n may be associated with a plurality of contact handlers, agents or representatives of the entity under the administration and management of the dynamic availability, capability and expertise based contact handler assignment and management system 200. For example, handler devices 204a-n may include computer workstations operated by customer service agents employed to interact with customers over the telephone. In such embodiments, a customer service agent may be associated with a handler device such as a personal computer or computer workstation, where the computer is in communication with contact processing server 202. In other embodiments, handler devices 204a-n may be computing devices configured with software to also communicate with client devices 208a-n to obtain information directly from the customer or third party.

Contact director or processing server 202 includes a number of different sub-systems, engines or modules, each of which may configured to perform processing to support operation of the contact processing server as described herein. For example, as depicted, contact processing server 202 includes inquiry evaluation module 210. One or more of all of the modules may operate on data obtained from contact handler devices 204a-n, client devices 208a-n, auxiliary devices 210a-n and one or more data sources including data stores 232a-n. For example, inquiry evaluation module 210 operates to receive data from client interface layer 206 and/or retrieve data from and one or more data stores 232a-n to evaluate the inquiry such as the substantive subject matter of the inquiry.

Inquiry evaluation module 210 operates to dynamically scan, process and classify inquiries received. For example, an electronic email inquiry may be text mined to determine the subject of the message and a voice initiated message may be classified or categorized based on one or more inputs provided through an interactive voice response unit or alternatively through voice recognition technology which can be used in conjunction with or in place of an interactive voice response unit. In other and related embodiments, inquiry evaluation module 210 may classify inquiries based on pre-defined criteria such as which telephone number the inquiry was initiated on which may indicate that the party had a certain question or inquiry for a specific subject matter for which the telephone number was provided, e.g. in one specific example, an insurance company may provide a telephone number such as 1-800-XXX-YY for inquiries related to property insurance.

Server 202 further includes a handler director module 214 which operates to manage, track and assign tasks and activities to appropriate handlers, employees or agents based at least in part on the characteristics of a given inquiry received from inquiry evaluation module 210 and data from one or more subsystems or engines for evaluating the availability and substantive qualifications of one or more contact handlers. In one embodiment, director module 214 includes one or more sub modules or engines such as a business rules engine 216, a trending analytics engine 218, a skills availability engine 220, an online availability engine 222 and a dynamic feedback engine 224.

As shown in FIG. 2, business rules engine 216 receives, stores, processes and manages the various business rules and algorithms defining interactions between third party and customer inquiries, contact handlers, vendors, insurance company personnel and other related parties. Business rules can be provided in any number of proprietary and public formats and methodologies including but not limited to Unified Modeling Language, Business Process Execution Language, Web Services Policy Framework, Business Process Modeling Notation, and/or Semantics of Business Vocabulary and Business Rules. For example, with business rules engine 216, rules can be entered that will affect how expertise, online availability, dynamic feedback affect the assignment of contacts. Business rules may also be specified as to how available contact handlers are ranked for their expertise, capabilities and availability.

Any suitable rule/algorithm encompassing the contact handlers' availability, capability and expertise may be used by business rules engine 216 to process the contact handler information and determine the desirable assessment, allocation and assignment of contact handlers and corresponding contact inquiries. For example, in one embodiment, the assessment and assignment of contact handlers may be based on at least in part on the relative availability, capability and subject matter expertise of each contact handler. Thus, the contact handler having the highest availability and most varied capability and expertise is listed as the most preferred call inquiry handler and the contact handler having the lowest relative availability, capability and subject matter expertise is listed as the least preferred destination address. A similar approach can be used for any other quantitative metric, such as available network bandwidth, available processor capacity, existing work queues, and other similar considerations, whereby the contact handler address having the least workload and most subject matter relevancy is the most preferred contact handler and that having the most workload and least subject matter expertise is the least preferred contact handler.

Director module 214 also includes a trending analytics engine 218 to process, store and aggregate historical performance rankings of one or more contact handlers. Historical ranking may be processed, stored and aggregated according to past performance data representative of prior contact handling performance. Trending analytics engine 218 works in conjunction with business rules engine 216 to rank contact handlers based at least in part on their historical performance based on contact feedback and/or relative to performance of other contact handlers.

Director module 214 also further includes an expertise or skills availability engine 220 which processes expertise or skills related data for one or more contact handlers. Such data may be provided by the contact handlers themselves, via an expertise assessment authority to correlate a handler with a level of expertise, peer skill assessment and review and/or through historical subject matter contact experience. Skills availability engine 220 assists with correlation of handling of a specific type of contact inquiry as may be determined by the present invention.

Director module 214 also includes an on-line availability/capability engine 222 which helps determine handler availability for contact handling. This engine aggregates availability data and signals from one or more sources and correlates them to capabilities so that a holistic evaluation of a handler's availability can be assessed. On-line availability engine 222 may receive signals indicative of the availability of a contact handler, such as whether they are available via telephone, computer or other communication device. For example when contact handler answers the call, an off-hook signal is communicated through internal telephone network to on-line availability engine 222 to signal that the contact handler is not available via telephone. Such information may also be conveyed to on-line availability engine 222 through a signaling channel such as an out-of-band ISDN message via SIP or other similar communication mechanism. Such availability information is also reconciled with contact handler capability information such as whether the contact handler has computer capability, telephone capability, video capability, mobile capability, etc. It is contemplated that each handler capability has a mechanism for signaling the availability or unavailability of such capability, such as discussed above with respect to the telephone availability.

By way of further example, a contact handler's personal computer capability may be evaluated based on network presence information tied to a contact handler's MAC media access control (MAC) identification, network ID, hardware address identification or alternatively their internet protocol (IP) address. In one embodiment, each contact handler may have trackable addresses which are statically or dynamically assignable to each contact handler thereby permitting on-line availability engine 220 to assess which contact handlers have availability based on the status of their respective capabilities.

As used herein, a user's “presence” may include both the physical location of a user and their respective communication/electronic state of the user, and various combinations thereof. By way of example, presence data related to the contact handler's location may include an intra-office designation of their location, the country, state or city in which the user is currently located, the relative distance between the contact handler and the third party inquiry, or the exact geo-location of the user such as the longitude and latitude or other coordinates. The electronic presence of the user includes information related to whether the user is currently online e.g., logged in to the contact handler system as described later herein in more detail.

Referring still to FIG. 2, contact handler may specify certain preferences for receiving contact inquiries via skill availability engine 220 and/or online availability engine 222. For example, a contact handler may indicate delivery preferences, such as whether the contact handler prefers to receive certain inquiries, in this case via e-mail, phone, online facility, etc. The contact handler's preference for receiving inquiries may be used as a factor in determining assignments of contact inquiries. The delivery preference indication may be designed in many different ways within the scope of the present invention such as a high, medium or low designation made to each mode of communication or capability.

Director module 214 also includes a dynamic feedback engine 224 for the collection, aggregation and assessment of contact handler related dynamic feedback. This dynamic feedback may be used as another factor in determining the overall availability of an agent to handle a particular contact type. Dynamic feedback data may be obtained from one or more satisfaction surveys, peer/supervisor review and also based on a community assessment or evaluation of handlers' expertise. In the present invention, expertise from social networks or web communities will greatly enhance or compliment the codified expertise and lend to enhanced automation and greater efficiency of system 200. Exemplary networking or community web sites include Orkut™, LinkedIn™, Facebook™, or MySpace™. It is contemplated that such community or networking sites may be public external sites such as the foregoing example, but may also be a combination of public and/or private networking or community sites which may be used in evaluating expertise in the present invention. Such sites may also be personal, professional and/or a combination of personal and professional in nature. Data and information on such sites may be pushed or pulled to system 200 through a variety of communication interfaces.

Referring still to FIG. 2, an auxiliary interface module 230 operates to interface communications between, for example, internal and/or third party vendor systems 210a-n and inquiry data associated with inquiries processed using contact processing server 202. Such internal and/or third party vendor systems 210a-n may contain information suitable for further processing or handling of a contact inquiry such as for facilitating binding an insurance policy after an initial inquiry from a customer or for interface with a third party vendor who may have information suitable for resolving the customer inquiry.

Referring still to FIG. 2, in one embodiment, once the overall availability, capability and expertise rating of the handlers are determined, the most suitably rated or ranked handler and appropriate capability is assigned the contact via contact delivery/assignment module 240. Pursuant to some embodiments, director module 214 may access one or more separate data stores 260 to store information related to customer inquiries and handler assignments. Data stores 260 may include any number of storage devices or mediums including random access memory (RAM), read-only memory (ROM), computer-readable media, storage mediums, virtual memory, removable disk, optical, magnetic, etc.

Those skilled in the art will appreciate that some or all of the modules shown and described herein may be implemented using shared code or using different servers. Some of the modules may be based on or comprise software, either fully customized or in combination with certain off the shelf software components. In some embodiments, for example, contact processing server 202 may be comprised of an application server in communication with one or more database servers (where the database server stores or otherwise accesses data from data stores 260). In some embodiments, contact processing server 202 may be set up with a mirrored or secondary/tertiary servers to ensure high reliability and scalability.

Although a single contact processing server 202 is shown in FIG. 2, any number of contact processing servers 202 may be included in the system 200. Similarly, any number of devices 204, 206, 208 (and any other devices described herein) may be included as part or integrated with server 202 according to embodiments of the present invention. Note that the contact processing server 202 might comprise one or more servers adapted to receive, store, process and/or transmit inquiry information associated with customers and contact handlers and/or data.

In some embodiments, contact processing server 202 may be associated with, for example, an insurance company processing inquiries solely for that company, or with an independent entity (e.g., independent of the insurance company) such as a third party administrator or TPA that operates a inquiry processing service on behalf of the insurance company. Moreover, the contact processing server 202 may operate in accordance with any of the embodiments described herein.

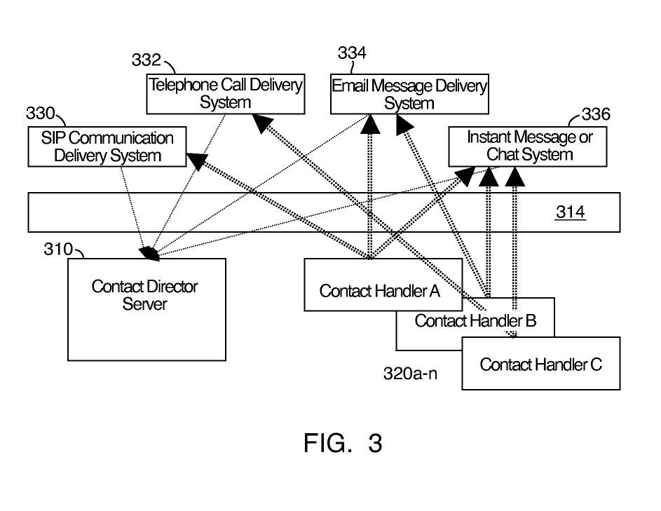

Referring to FIG. 3, an information/data flow diagram is shown for communications between a contact handler server and contact handlers of the present invention. As shown in FIG. 3, a contact handler/director server 310 is in communication with one or more contact handlers' 320a-n via communication intermediary or proxy 314 with message systems 330-336. Communication intermediary 314 facilitates the various servers and clients to communicate even though they may have different communication modes, platforms, protocols and runtime environments and are running on different platforms. In one instance, communication may be accomplished using well-known protocols like HyperText Transfer Protocol (“HTTP”) over TCP/IP. Other network communication protocols include Internet Interoperable Protocol (“IIOP”) that permits communication between different computer platforms over a network. One example of a technology that uses IIOP would be the Common Object Request Broker Architecture. (“CORBA”). At a high-level CORBA specifies many standards involving application level communication among disparate applications and computing platforms. Communication intermediary 314 may also process network load or traffic related information for assisting in determining optimum contact handler selection. For example, if the telephony message system 332 is experiencing high call volume at a given time, and an electronic mail system 334 is experiencing relatively low electronic mail traffic at a given time, then preference weighting is given to contact handlers having the appropriate availability and expertise that have electronic mail capability at that time.

Message systems 330-336 include but are not limited to Session Initiation Protocol (SIP) message system 330, telephony message system 332, electronic mail system 334 and instant message system 336. In one embodiment, contact handlers 320a-n may register with one or more of the message systems 330-336 to initiate receipt and delivery of contact inquiries via each respective message system. Each respective message system may then communicate with contact handler server 310. It is contemplated that contact handler server 310 and systems 330-336 may incorporate one or more end-to-end authentication mechanisms to facilitate secure registration and communications between contact server 310, contact handlers 320a-n and message systems 330-336.

By way of example, an exemplary session initiation operation in which a contact handler 320a operating a SIP client wants to initiate a communication session thereby sends login information to SIP system 330 that identifies contact handler 320a with SIP system 330. It is contemplated that any number of multimedia communication sessions such as voice and video calls over the Internet, video conferencing, and other communication sessions may be initiated via intermediate bus 314. SIP system 330 in turn registers contact handler 320a with contact handler server 310. In the context of communications under the SIP protocol, communications are now established as between contact server 310 via SIP system 330 and contact handler 320a such that contact handler 320a is now able to receive contact inquiries from contact server 310. It is contemplated that such contact inquiries may be encrypted for secure communications between contact server 310 and contact handler 320a.

Referring still to FIG. 3, intermediate proxy/bus 314 may also perform other functions content caching, firewalling and other related functions. In various embodiments, the proxy 314 may be integrated with, combined with, included in, or it may include, a telephony switch, a gateway such as one which converts messages between wireless access protocol (WAP) used on a wireless subnetwork and HTTP used on a landline subnetwork, or other device.

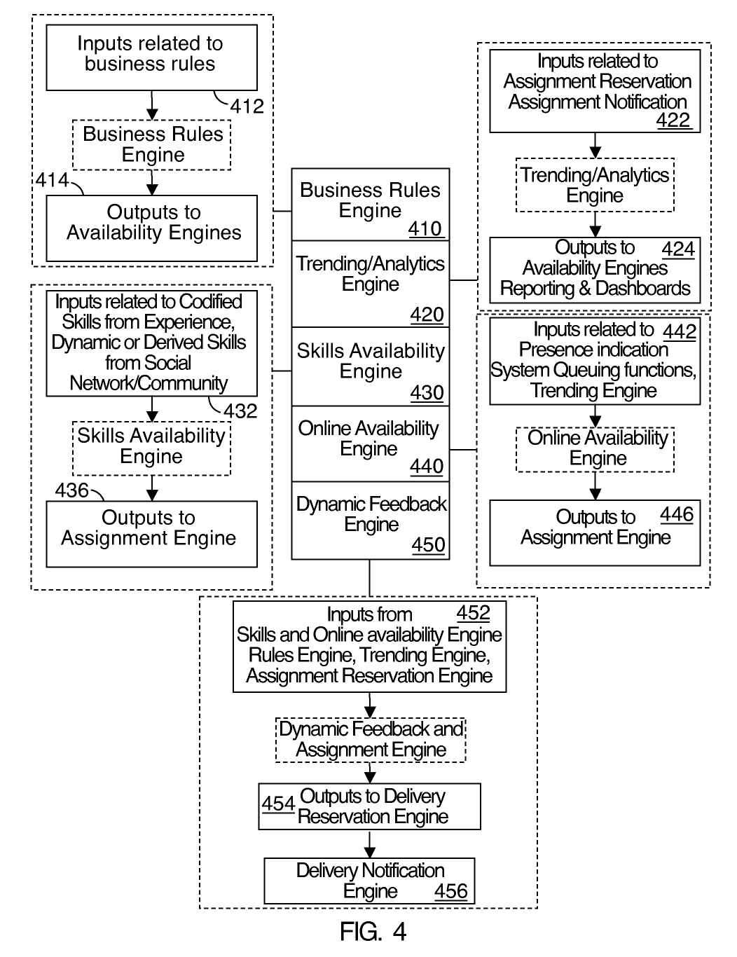

Referring now to FIG. 4, an exemplary input/output data flow diagram is shown for the various data and information flows accomplished via one or more engines or modules, such as business rules engine 410, trending/analytic engine 420, skills availability engine 430, online availability engine 440 and dynamic feedback engine 450. The various engines or modules shown and described may be facilitated and run on one or more specialized hardware and software implementations and combinations. Such hardware/software systems may typically include a processor, memory device, a storage device, input/output devices, internal buses, and/or a communications interface for communicating with other computer systems in conjunction with communication hardware and software, etc.

In the present invention, one or more of the business rules engine 410, trending analytics engine 420, skills availability engine 430, online availability engine 440 and the dynamic feedback engine 450 may also be implemented as modules. For example, a business rules module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of computer processors. A module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, comprise the module and achieve the stated purpose for the module such as implementing the business rules logic prescribed by the contact handler system. In the present invention a module of executable code may be a compilation of many instructions, and may even be distributed over several different code partitions or segments, among different programs, and across several devices. Similarly, contact handler and inquiry data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a contact handler system and/or network as shown and describe herein.

As shown in FIG. 4, business rules engine 410 receives inputs 412 related to one or more business rules and outputs to one or more availability engines 414. Trending analytics engine 420 receives inputs 422 related to contact handler assignment reservation and assignment as discussed with respect to FIG. 1 above. Trending analytics engine 420 provides output 424 to one or more availability related engines and one or more reporting mechanisms and dashboards. For example, trending analytics engine 420 may output information which may be compiled into a report, and/or presented graphically, for example, via a reporting dashboard. Such graphical presentation can provide information regarding the various contact handler reservations, notifications, etc. Such reports and/or graphical presentations can provide a manager for the insurance company or another designated recipient, depending upon the configuration of the system, with important data regarding not only the contact handling activities being performed and scheduled for performance. The reports can be provided via specially designed electronic dashboards configured to aid in decision support and analysis for a particular contact handler's area of expertise.

Referring still to FIG. 4, skills availability engine 430 receives inputs 432 related to contact handler skills which may be derived from contract handling experience and/or dynamic or derived skill from social networking or community type assessment as discussed herein. For example, skills availability engine 430 may receive input and/or poll one or more social networking sites to see keywords related to interests or skills related to a certain contact handler. By way of further example, a contact handler's list of prior job, interests and skill may be parsed on a professional networking site to determine if the contact handler has the appropriate skills or expertise for an inquiry. In another example, images and/or text posted up by a contact handler on a personal networking site may give an indication as to the expertise of the contact handler. Skills availability engine 430 outputs to assignment module or engine 436. Online availability engine 440 receives inputs 442 related to contact handler presence, system queuing functions and additionally accepts input from trending analytics engine 420. Online availability engine 440 also outputs to assignment module 446. Dynamic feedback engine 450 receives inputs 452 from skills availability engine 430. Dynamic feedback engine 450 outputs to delivery reservation engine 454 and delivery notification engine or module 456.

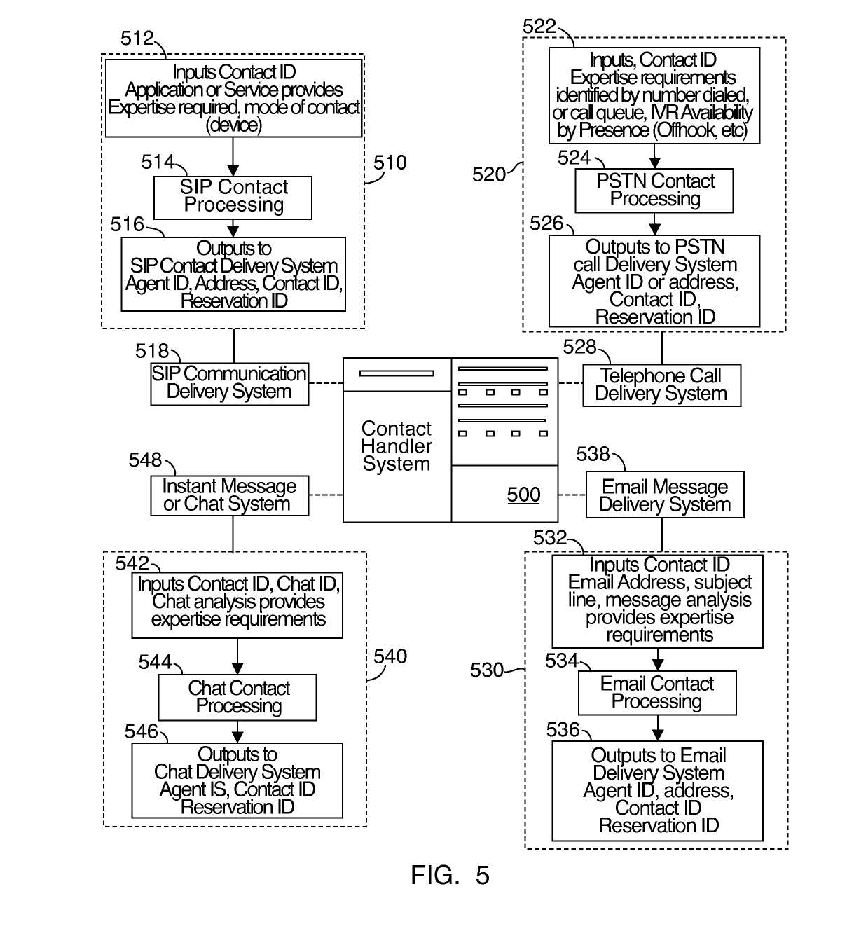

Referring now to FIG. 5, an exemplary diagram of communication information processing processes between contact handler system 500 and various message sub-systems such as Session Initiation Protocol (SIP) message system 510, PSTN/telephony message system 520, electronic mail system 530 and instant message/chat system 540. In one exemplary embodiment, SIP communication system 510 accepts inputs, for example, related to expertise required and contact identification 512, performs processing 514 and outputs information such as agent ID, address, contact ID, and reservation ID for delivery by SIP communication delivery system or module 518. Telephony system 520 accepts inputs, for example, related to expertise required, presence information, etc. 522, and performs processing 524 and outputs information such as agent ID, address, contact ID, and reservation ID for delivery by telephony communication delivery system or module 528. Electronic mail system 530 accepts inputs, for example, related to expertise required, email address, etc. performs processing 534 and outputs information such as agent ID, address, contact ID, and reservation ID 536 for delivery by electronic mail communication delivery system or module 538. Messaging system 540 accepts inputs, for example, related to expertise required, chat ID, etc., performs processing 544 and outputs information such as agent ID, address, contact ID, and reservation ID 546 for delivery by messaging communication delivery system or module 548.

Referring still to FIG. 5, contact handler system 500 uses the native capabilities in each delivery system to deliver the contact. Contact handler system 500 tells the delivery system where it is best to deliver it. The delivery system will then provide a status as to handler as to the disposition of the contact periodically until the contact is resolved. In one embodiment, each delivery module or sub-system includes least one queue handler connected to the communications network, and each queue handler includes an input port at a respective network address of the communications network and a ranked set of output ports at respective network addresses of the communications network, each output port having an associated destination address store.

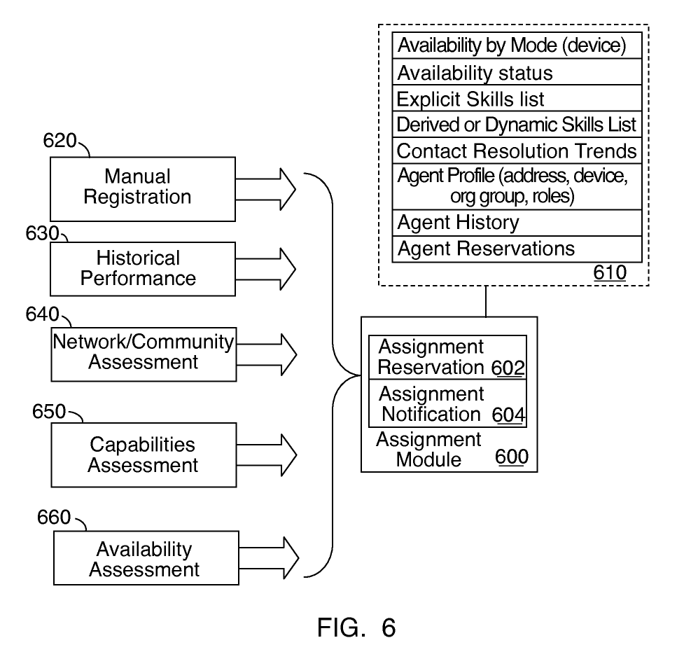

Referring now to FIG. 6, one embodiment of an assignment director module 600 is shown for intelligently and dynamically assignment contact handlers to contact inquiries. Assignment director module 600 includes an assignment reservation sub module 602 and an assignment notification sub module 604 to assign contact handlers based on specific contact handler or agent factors 610. Such factors may include availability by mode or device, availability status, explicit skills, derive or dynamic skills, contact resolution trends, agent profile, agent history and agent reservations. Assignment director module 600 accepts a variety of system inputs such as from a manual registration module 620, a historical performance module 630, a social networking or community assessment module 640, a capabilities assessment module 650 and an availability assessment module 660. In one embodiment, manual registration module 620 permits contact handlers to manually specify their specific interests and skill sets. Historical performance module 630 provides capabilities for historically assessing and compiling contact handler performance over periods of time. Community assessment module 640 provides capabilities for compiling and aggregating contact handler peer performance and expertise. Capabilities assessment module 650 provides capabilities for determining and capturing individual and group capabilities. Availability assessment module 660 provides capabilities for capturing and managing individual and group contact handler availability. Each of these aforementioned modules may be used to provide information related to the factors such as availability by mode or device, availability status, explicit skills, derive or dynamic skills, contact resolution trends, agent profile, agent history and agent reservations to make the contact handler assignments and notifications via assignment director module 600.

In the present invention, specific contact handler or agent factors 610 may include data input from handlers/agents and managers regarding training history and skills as well as data feeds from current state licensing for sales agents databases and feeds, product training data and any other training data available, such as online training course feeds. The foregoing registration process is completed for all entities utilizing the contact handler. The contact delivery related systems such as a PBX will register with the handler to ensure the proper inputs and outputs can be received via its preferred communications methods, Communities are registered so that expertise determinations can be appropriate utilized. Handlers are registered so that the methods that determine their capabilities, availability and expertise can be associated with them. The record in 610 is an example of what type of information is captured for each handler. The assignment reservation engine will utilize the records to start queues for each contact handler, The reservation system will keep track of all contacts and where they are supposed to be handled and will receive and give information to the assignment notification engine to get information to and from the contact delivery systems outside of the handler.

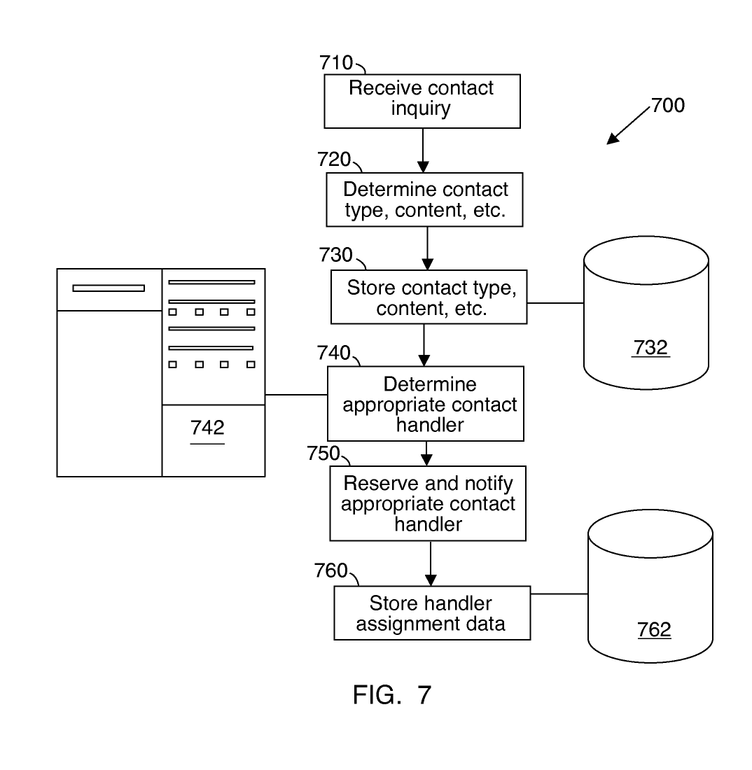

Referring to FIG. 7, one exemplary inquiry processing method 700 begins at 710, where dynamic availability, capability and expertise based contact handler assignment and management system 100 receives a customer contact inquiry and performs initial contact processing, evaluation and routing. For example, referring to the elements of FIGS. 1 and 2, customer or third party contact may be received in a number of ways, including via telephone contact where the customer operates a telephone such as a PBX or IVR unit or direct to an agent operating a handler device, 710. The flow charts described herein do not imply a fixed order to the steps, and embodiments of the present invention may be practiced in any order that is practicable. Processing at 720 may include determining the contact type, prescreening the contact and identifying the type of contact. For example, in some embodiments, processing at 710 includes identifying the customer (e.g., by text scanning in an electronic mail message, direct questioning by a live agent, by a phone directory lookup in an IVR, or the like) and identifying the type of contact or inquiry being made (e.g., again by direct questioning by a live agent, by a voice menu in an IVR or PBX system, or the like). In general, processing at 710 includes processing to identify who is calling (or otherwise making contact), and what the purpose of the call or contact is. For example, in some embodiments, a determination is made whether the customer is making a policy related inquiry or to information regarding a new policy and then routing the contact to a handler who is currently available, has appropriate capability and is designated qualified handling inquiries related to that specific substantive inquiry in that specific capability through which the inquiry was made.

The information obtained at 720 is then stored in one or more database repositories such as database 732. Those skilled in the art, upon reading this disclosure, will appreciate that different inquiries and will require a wide variety of types of data to be collected, processed and stored. The stored information is then used to preliminarily route the contact to an appropriate handler, 740, based at least in part on the identified contact type, subject matter and customer information in conjunction with capability, availability and expertise information from server, 742. Embodiments of the present invention allow the dynamic and efficient creation of contact handler selection intelligence and algorithms that are relevant to different inquiries and different policies so that handlers (such as call center representatives) ask and receive data that is relevant to a particular inquiry. This ensures that processing time is reduced and errors minimized and the customer or potential customer experience is enhanced as well as leading to greater job satisfaction and interest in the part of the contact handler or agent. Referring still to FIG. 7, once a contact handler is selected, the contact handler is reserved and notified, 750. In the present invention, the system would notify the contact delivery system in addition to the contact handler. The contact handler would maintain a feedback loop with the delivery system until the contact is resolved. The contact handler assignment is then stored, 760. Such data may be stored in database 762. The stored data may be later processed to perform historical contact handler performance data.

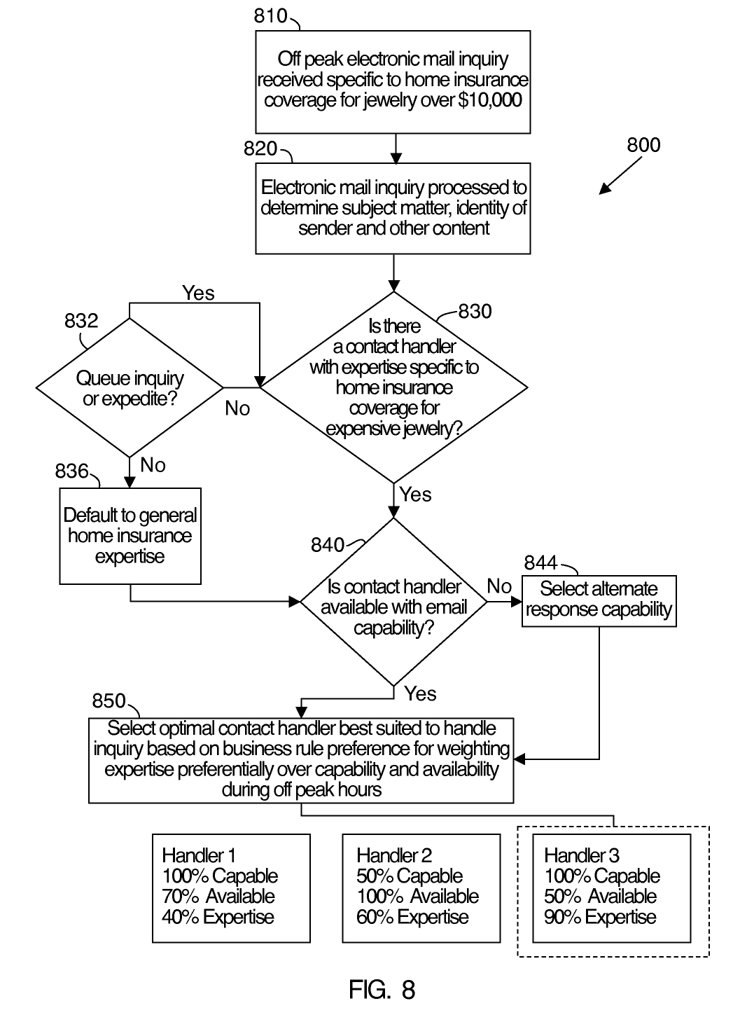

Referring to FIG. 8, one illustrative embodiment of a contact handling inquiry process flow is illustrated. In this exemplary embodiment, an electronic mail inquiry is received during off peak hours, e.g. outside of 9 am to 5 pm, 810. For exemplary purposes, the inquiry relates to a specific question regarding home insurance coverage for jewelry worth over $10,000. The process continues whereby the electronic mail inquiry is processed to determine the subject matter, identity of the sender and any other content, 820. For example, information about the inquiry may be derived from the destination email address which may indicate that the inquiry is related to a certain subject matter. In other instance, text mining may be used to review the electronic mail text to derive certain keywords which may provide an indication of the subject matter of the content. Once such preliminary information about the inquiry is derived, it is determined if there is a contact handler with the matching expertise for the inquiry, 830. In this case, the desired contact handler would have expertise in home insurance for jewelry or high value items. If such a contact handler exists, then it is determined if the contact handler has the required capability and availability, 840. If no such handler is available, the inquiry may be queued or expedited, 832. In the present invention it is contemplated that if it is expedited, the system may use less stringent criteria for picking the next capable handler. It is contemplated that inquiry volume and specific queue length may be factored into one or more business rules to determine whether an inquiry may be queued or expedited. Volume and queue length could be driven in part by factors such as day of week, time of day, holiday, external events (press on insurer, weather events, etc.). If not queued or expedited, then the system may default to a contact handler with general home related insurance expertise, 836. If a contact handler with the required expertise is available but does not have the requisite capability, such as electronic mail, an alternate capability, such as chat or telephony is selected, 844. The optimal contact handler based on the handlers capability, availability and expertise is then selected, 850. In this instance, based on the defined business rules for off-peak contact handler selection for home insurance related question, a handler is selected have the desired capability/availability/expertise profile or score.

It is contemplated that business rules engine, such as engine 216 in FIG. 2 may include a variety of business rules to accommodate a variety of contact inquiries and the circumstances around each inquiry. For example, certain business rules may factor in whether or not the contact inquiry is a repeat inquiry within a certain specified time frame. Other factors may include whether or not the contact inquiry is from a recent policyholder or a long standing policyholder with the assumption that new customers may have more rudimentary questions about the basic provisions of their contract and thus may be routed to contact handlers experienced with new customers and new customer issues. Additionally, other business rules may take into account factors such as whether an inquiry is from someone recently involved in a claim, or a complexity rating of a product in question.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the databases shown and described herein may be combined or stored in external systems). Moreover, although examples of specific types of inquiries involving automobile losses have been used, embodiments of the present invention could be used with other types of inquiries. Further, while embodiments were described in which customers interact with handlers (such as customer service representatives), other embodiments may involve customers interacting directly with a contact processing server via a computer interface in which the screens and data are also presented directly to the customer.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended inquiries.

What is claimed:

1. An intelligent contact handler management system for routing contact inquiries based on contact handler availability, capability and expertise, comprising:
a plurality of contact handler communication devices adapted to receive and transmit information;
a communication interface in communication with said plurality of contact handler communication devices, said communication interface adapted for a plurality of communication capabilities;
a processor coupled to the communication interface; and
a storage device in communication with said processor for storing instructions adapted to be executed by said processor to:
receiving a contact inquiry;
parsing the contact inquiry to determine a contact mode and a contact type;
determining an optimal contact handler selection based at least in part on contact mode, contact type, contact handler availability, contact handler capability and contact handler expertise, wherein contact handler expertise is based at least in part on community derived expertise information;
dynamically generating at least a first contact handler assignment; and
transmitting notification via said communication interface to said contact handler communication device of said at least first contact handler assignment.

2. The system of claim 1, said storage device further storing instructions adapted to be executed by said processor to:
receiving contact handler communication preferences; and
determining the optimal contact handler selection provided the contact handler communication preference is not in conflict with a communication preference specified in the contact inquiry.

3. The system of claim 1, wherein said contact handler communication device is in communication with at least two of an electronic mail sub-system, a chat sub-system, an interactive voice response based telephony system and a session initiation protocol subsystem.

4. The system of claim 3, wherein said communication interface is in communication with at least two of said contact handler's electronic mail sub-system, chat sub-system, interactive voice response based telephony system and session initiation protocol subsystem

5. The system of claim 1, wherein said contact handler expertise is a function at least in part of contact handler historical performance and manual contact handler registration.

6. The system of claim 1, wherein said communication interface is an intermediate bus for brokering contact handler communications via a plurality of communication capabilities.

7. The system of claim 1, wherein community derived expertise is based on one or more public social networking sites.

8. The system of claim 7, wherein said determining an optimal contact handler selection includes:
identifying at least a first business rule related to contact handler selection; and
processing to compare said first business rule with contact handler availability, capability and expertise information to determine a conforming handler selection based on the at least first business rule.

9. The system of claim 8, said storage device further storing instructions adapted to be executed by said processor to:
track said assigned contact handler resolution progress on said contact inquiry.

10. The system of claim 1, wherein the contact handler management and processing system further includes:
a plurality of contact handler communication device adapted for communication in a plurality of communication modes.

11. The system of claim 10, said storage device further storing instructions adapted to be executed by said processor to:
evaluate trending related information related to contact handler assignments and historical performance.

12. The system of claim 1, said storage device further storing instructions adapted to be executed by said processor to:
establish a reservation with one or more contact handlers for one or more contact inquiries.

13. The system of claim 1, wherein said communication interface receives contact handler login information and transmits said login information to one or more of an electronic mail sub-system, a chat sub-system, an interactive voice response based telephony system and a session initiation protocol subsystem

14. The system of claim 13, further comprising:
a database to store at least two of: (i) a contact handler skills database, (ii) a business rule/availability database, (iii) an inquiries database, and (iv) a policy information database.

15. A computer implemented method of intelligently routing a plurality of customer contact inquiries in a variety of communication mediums, comprising:
receiving a customer inquiry in a communications module in communication with said variety of communication mediums;
storing said customer inquiry in a storage module;
processing said stored customer inquiry in an inquiry evaluation module to determine preliminary inquiry routing information;
comparing in a handler director module said preliminary routing information with contact handler capability, availability and expertise information;
dynamically generating in said handler director module a contact handler assignment based at least in part on the preliminary routing information, contact handler capability, availability and expertise information, wherein the expertise information is at least partially derived from social networking information;
reserving a primary handler through a reservation module based on the handler assignment generated;
notifying said primary handler through a notification module;
transmitting said inquiry data to said contact handler through said communications module; and
establishing a communications link between the contact handler and the customer through said communications module.

16. The computer implemented method of claim 15, further comprising:
identifying at least a first business rule associated with said preliminary routing information and
comparing said preliminary routing information to said at least first business rule/availability to identify one or more contingent contact handlers for assignment.

17. The computer implemented method of claim 16, wherein said contact handler capability, availability and expertise information is derived in combination with manual registration and public and private social networking derived information.

18. The computer implemented method of claim 15, wherein the communications module is adapted for communication with at least two of an electronic mail module, a telephony module, an instant message module and a SIP module.

19. The computer implemented method of claim 15, further comprising:
receiving dynamic handler performance input.

20. The computer implemented method of claim 15, wherein handler expertise is weighted more heavily than availability in determining assignments.

21. The computer implemented method of claim 15, wherein dynamically generating in said handler director module a contact handler assignment includes comparing network load traffic information for the variety of communication mediums.

22. An intelligent contact handler management system for processing contact inquiries based on contact handler availability, capability and expertise, comprising:
a communications interface in communication with a plurality of contact handler communication devices, said communication interface adapted for a plurality of communication capabilities;
a processor coupled to the communication interface; and
a storage device in communication with said processor for storing instructions adapted to be executed by said processor to:
receiving a contact inquiry;
parsing the contact inquiry to determine a contact mode and a contact type;
determining an optimal contact handler selection based at least in part on contact mode, contact type, contact handler availability, contact handler capability and contact handler expertise, wherein contact handler expertise is based at least in part on community derived expertise information;
dynamically generating at least a first contact handler assignment; and
transmitting notification via said communications interface to said contact handler communication device of said at least first contact handler assignment.

23. The system of claim 22, said storage device further storing instructions adapted to be executed by said processor to:
access one or more networking sites to obtain said community derived expertise information.

24. The system of claim 23, wherein said networking sites include at least one of a private networking site and a public networking site.

25. The system of claim 23, wherein said networking sites include a professional networking site and a social networking site.

26. The system of claim 22, wherein said contact inquiry specifies a desired handler capability.
